(19) United States
(12) Patent Application Publication
(10) Pub. No.: US 2026/0360587 A1
(43) Pub. Date: Nov. 12, 2026

(54) FLAT CIRCUIT BODY AND CIRCUIT WIRING STRUCTURE

(71) Applicant: YAZAKI CORPORATION, Tokyo (JP)

(72) Inventors: Kenichi Katsumata, Susono-shi (JP); Mitsuhisa Sano, Susono-shi (JP)

(21) Appl. No.: 19/645,699

(22) Filed: Apr. 13, 2026

(30) Foreign Application Priority Data
May 12, 2025 (JP) 2025-079574

(51) Int. Cl. H01B 7/08; H01B 7/04; H01B 7/17; H01R 11/01; H02G 3/08

(52) U.S. Cl. CPC H01B 7/0823; H01B 7/04; H01B 7/17; H01R 11/01; H02G 3/08

(57) ABSTRACT

A flat circuit body has a flat shape. The flat circuit body includes a plurality of signal lines that transmit a communication signal; a power supply line that transmits power; an insulator that supports the plurality of signal lines and the power supply line; and an electric conductive shield layer. The plurality of signal lines are spaced apart from each other with a gap therebetween in a width direction of the flat circuit body. The power supply line has a cross-sectional area larger than a cross-sectional area of one of the plurality of signal lines and is disposed with a gap from the plurality of signal lines. The insulator supports the plurality of signal lines and the power supply line in a manner of maintaining relative positions of the plurality of signal lines and the power supply line.

### CROSS-REFERENCE TO RELATED APPLICATIONS

This application is based on and claims priority under 35 USC 119 from Japanese Patent Application No. 2025-079574 filed on May 12, 2025, the contents of which are incorporated herein by reference.

### TECHNICAL FIELD

The present disclosure relates to a flat circuit body having a flat shape and including a plurality of signal lines, a power supply line, an insulator that supports the plurality of signal lines and the power supply line, and an electric conductive shield layer, and a circuit wiring structure using the flat circuit body.

### BACKGROUND ART

In the related art, a circuit body connecting a power supply mounted on a vehicle or the like, an electric junction box, various electrical components, and the like has been known (for example, see Patent Literature 1).

### Citation List

### Patent Literature

Patent Literature 1: JP2005-078962A

### SUMMARY OF INVENTION

Incidentally, the above-mentioned type of circuit body is generally configured such that a bundle of electric wires integrated by bundling a plurality of electric wires and wrapping the electric wires with a tape or the like is inserted into a protective tube or the like. Due to the structure, the circuit body tends to increase in diameter as the number of circuits increases and become less likely to curve. From a viewpoint of wiring the circuit body in a limited installation space of a vehicle (for example, in an underfloor space of a vehicle), there is a demand for a circuit body that can be wired without requiring an excessively large installation space while maintaining a function required as the circuit body.

An object of the present disclosure is to provide a flat circuit body that can be wired without requiring an excessively large installation space while maintaining a function required as a circuit body, and a circuit wiring structure using the flat circuit body.

In order to achieve the above-described object, a flat circuit body and a circuit wiring structure according to the present disclosure are characterized as follows.

A flat circuit body has a flat shape. The flat circuit body includes a plurality of signal lines that transmit a communication signal; a power supply line that transmits power; an insulator that supports the plurality of signal lines and the power supply line; and an electric conductive shield layer. The plurality of signal lines are spaced apart from each other with a gap therebetween in a width direction of the flat circuit body. The power supply line has a cross-sectional area larger than a cross-sectional area of one of the plurality of signal lines and is disposed with a gap from the plurality of signal lines. The insulator supports the plurality of signal lines and the power supply line in a manner of maintaining relative positions of the plurality of signal lines and the power supply line.

A circuit wiring structure includes a pair of electric junction boxes; the flat circuit body described above; and a wiring target in which the flat circuit body is wired. The flat circuit body is wired between the pair of electric junction boxes to electrically connect the pair of electric junction boxes while being curved along a surface shape of the wiring target.

The flat circuit body according to the present disclosure has the flat shape as a whole. Further, the plurality of signal lines are arranged side by side with a gap therebetween in the width direction of the flat circuit body, and the power supply line is disposed with a gap from the plurality of signal lines. Further, the insulator supports the plurality of signal lines and the power supply line in a manner of maintaining the relative positions. Accordingly, the flat circuit body according to the present disclosure can appropriately insulate each of the plurality of signal lines from one another and appropriately insulate the plurality of signal lines from the power supply line. Further, since the circuit body according to the present disclosure has the flat shape, a thickness can be reduced and flexibility can be improved as compared with a case in which electric wires are simply bundled together as in the circuit body in the related art. Therefore, the flat circuit body according to the present disclosure can be wired without requiring an excessively large installation space while maintaining a function required as a circuit body.

In the circuit wiring structure of the present disclosure, by using the flat circuit body described above, it is possible to electrically connect the pair of electric junction boxes (for example, ECU or the like in which a control device is built) by the flat circuit body while curving the flat circuit body along the surface shape of the wiring target (for example, a floor material) between the pair of electric junction boxes. Accordingly, the circuit wiring structure according to the present disclosure can appropriately electrically connect the pair of electric junction boxes without requiring an excessively large space on the wiring target.

The present disclosure has been briefly described above. Further, details of the present disclosure will be further clarified by reading modes for carrying out the invention described below with reference to the accompanying drawings.

### BRIEF DESCRIPTION OF DRAWINGS

FIG. 1 is a perspective view showing a state in which a connector is connected to an end of a flat circuit body according to a first embodiment of the present disclosure;

FIG. 2 is a cross-sectional view taken along a line A-A in FIG. 1;

FIG. 3 is a cross-sectional view corresponding to FIG. 2 in a flat circuit body according to a second embodiment of the present disclosure;

FIG. 4 is a cross-sectional view corresponding to FIG. 2 in a flat circuit body according to a third embodiment of the present disclosure;

FIG. 5 is a schematic configuration diagram showing a state in which a circuit wiring structure according to any one of the first to third embodiments of the present disclosure is mounted on a vehicle body; and

FIG. 6 is a cross-sectional view showing a state in which a flat circuit body shown in FIG. 5 is flexibly deformed in accordance with unevenness of an upper face of a floor panel of a vehicle.

### DESCRIPTION OF EMBODIMENTS

### First Embodiment of Flat Circuit Body

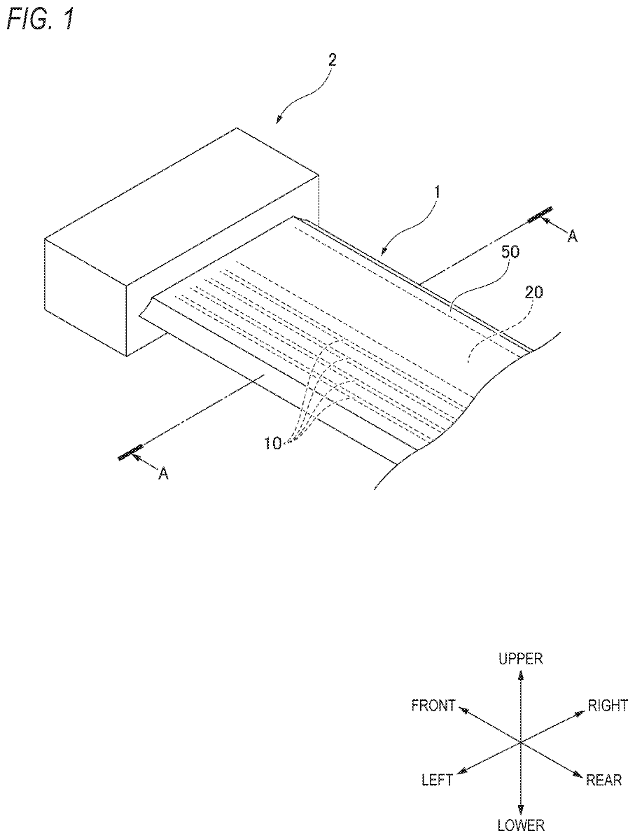

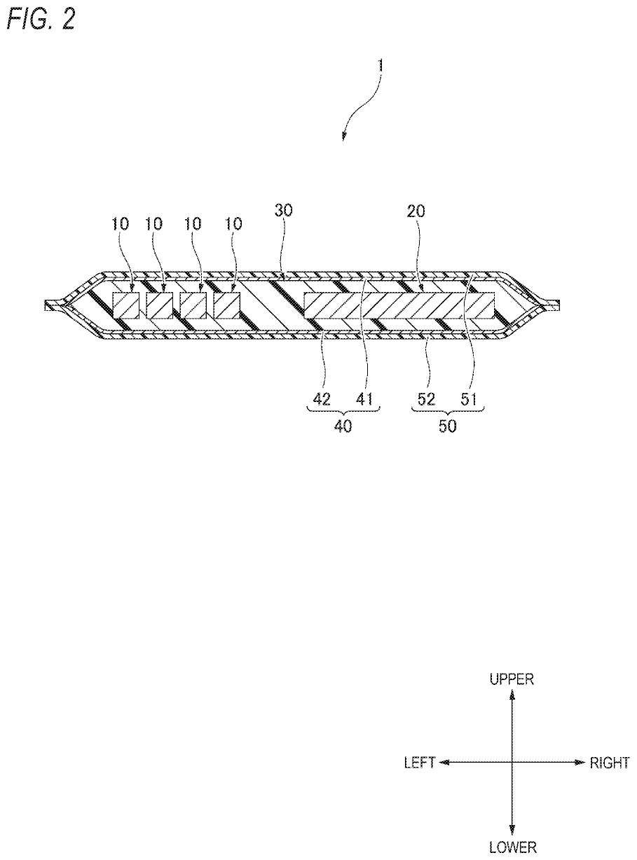

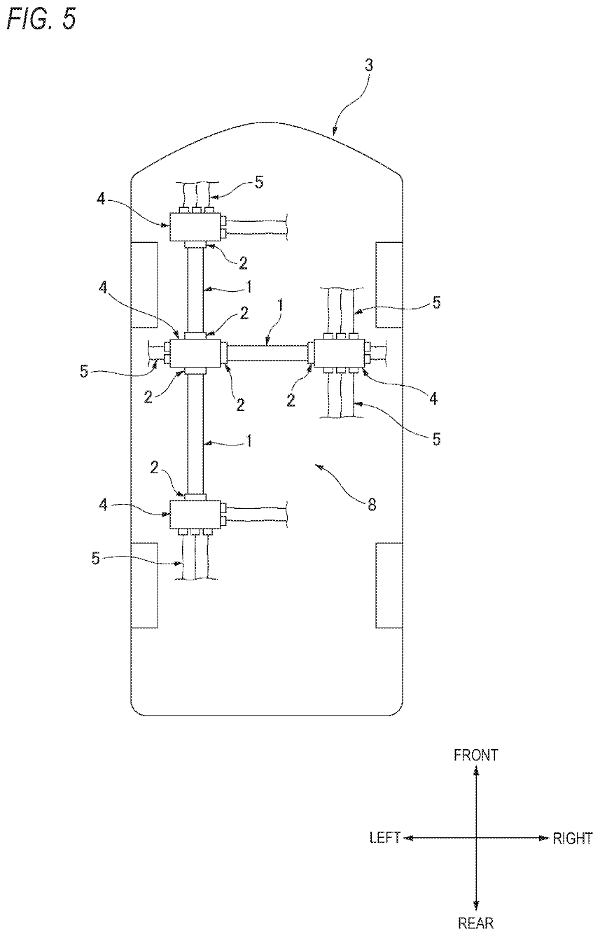

Hereinafter, a flat circuit body 1 according to a first embodiment of the present disclosure will be described with reference to FIGS. 1 and 2. As shown in FIG. 1, the flat circuit body 1 has an elongated flat shape extending in a length direction and a flat cross-sectional shape in which a dimension in a width direction is larger than a dimension in a thickness direction. For example, as shown in FIG. 5, the flat circuit body 1 is mounted on a vehicle and used in a state in which a connector 2 is connected to each of both ends of the flat circuit body 1 in the length direction.

Hereinafter, for convenience of description, “front”, “rear”, “left”, “right”, “upper”, and “lower” are defined as shown in FIG. 1 and the like. A “front-rear direction”, a “left-right direction”, and an “upper-lower direction” are orthogonal to one another. The front-rear direction corresponds to the length direction of the flat circuit body 1 (hereinafter referred to as the “length direction”), the left-right direction corresponds to the width direction of the flat circuit body 1 (hereinafter referred to as the “width direction”), and the upper-lower direction corresponds to the thickness direction of the flat circuit body 1 (hereinafter referred to as the “thickness direction”). The front-rear direction, the left-right direction, and the upper-lower direction do not necessarily coincide with a front-rear direction, a left-right direction, and an upper-lower direction of a vehicle when the flat circuit body 1 is mounted on the vehicle.

As shown in FIG. 2, the flat circuit body 1 includes a plurality of communication lines 10, one power supply line 20, an insulator 30 that supports the plurality of communication lines 10 and the power supply line 20, an electric conductive shield layer 40, and an insulating protective layer 50.

Each of the plurality of communication lines 10 is a conductor having a rod shape extending in the length direction and made of a metal material such as copper or aluminum. Each of the plurality of communication lines 10 may have any cross-sectional shape as long as the communication line 10 has a rod or linear shape extending in the length direction, and in an example shown in FIG. 2, the communication line 10 has a rectangular cross-sectional shape as an example. In the flat circuit body 1, the plurality of communication lines 10 are arranged in a row with gaps in the width direction. Some of the plurality of communication lines 10 function as signal lines for transmitting communication signals, and remaining communication lines 10 function as ground lines for reference potential (for example, for body grounding).

The power supply line 20 is a conductor having an elongated plate shape extending in the length direction, having a flat cross-sectional shape in which a dimension in the width direction is greater than a dimension in the thickness direction, and made of a metal material such as copper or aluminum. The power supply line 20 may have any cross-sectional shape as long as the power supply line 20 has a flat cross-sectional shape, and in the example shown in FIG. 2, the power supply line 20 has a rectangular cross-sectional shape that is long in the width direction and short in the thickness direction as an example. The power supply line 20 has a cross-sectional area larger than a cross-sectional area of one communication line 10. The power supply line 20 is electrically connected to a positive electrode side of a power supply of which a negative electrode side is grounded (for example, body-grounded), and functions to transmit power. In the flat circuit body 1, the plurality of communication lines 10 and the power supply line 20 are arranged in a row with a gap in the width direction.

The insulator 30 is an insulating resin molded body having an elongated plate shape extending in the length direction and having a flat cross-sectional shape in which a dimension in the width direction is greater than a dimension in the thickness direction, and is formed, for example, by extrusion molding. The insulator 30 covers the plurality of communication lines 10 and the power supply line 20 so as to be in close contact with an entire outer peripheral face of each of the plurality of communication lines 10 and an entire outer peripheral face of the power supply line 20. In other words, the plurality of communication lines 10 and the power supply line 20 are embedded in the insulator 30. Accordingly, the insulator 30 functions to support the plurality of communication lines 10 and the power supply line 20 in a manner of maintaining relative positions of the plurality of communication lines 10 and the power supply line 20. As a result, each of the plurality of communication lines 10 are appropriately insulated from one another via the insulator 30, and the plurality of communication lines 10 are appropriately insulated from the power supply line 20 via the insulator 30.

The shield layer 40 includes a thin film-shaped metal foil 41 extending in the width direction and in the length direction in a manner of covering an upper face of the insulator 30, and a thin film-shaped metal foil 42 extending in the width direction and in the length direction in a manner of covering a lower face of the insulator 30. Edge portions on one side in the width direction of the metal foil 41 and the metal foil 42 and edge portions on the other side in the width direction thereof are joined in the length direction, and thus the shield layer 40 has a tubular shape extending in the length direction. As a result, the shield layer 40 is disposed in a manner of surrounding the plurality of communication lines 10 and the power supply line 20. The shield layer 40 is connected (grounded) to the reference potential, thereby reducing an influence of an electromagnetic noise on the communication line 10 (signal line) from an outside of the flat circuit body 1 and reducing leakage of the communication signal transmitted through the communication line 10 (signal line). The shield layer 40 may be formed of one tubular metal foil extending in the length direction, or may be formed of a braided conductor.

The insulating protective layer 50 includes an insulating resin film 51 extending in the width direction and in the length direction in a manner of covering an upper face of the metal foil 41, and an insulating resin film 52 extending in the width direction and the length direction in a manner of covering a lower face of the metal foil 42. Edge portions on one side in the width direction of the resin film 51 and the resin film 52 and edge portions on the other side in the width direction thereof are joined in the length direction, and thus the insulating protective layer 50 has a tubular shape extending in the length direction. As a result, the insulating protective layer 50 is disposed in a manner of surrounding all members other than the insulating protective layer 50 constituting the flat circuit body 1, and functions to protect the flat circuit body 1 from the outside. The insulating protective layer 50 may be formed of one tubular resin film extending in the length direction.

The flat circuit body 1 having the configuration described above has excellent flexibility, and can be wired in a manner of extending in the length direction while being flexibly curved (bent) in the thickness direction. Impedance of the flat circuit body 1 can be appropriately adjusted by changing dielectric characteristics (for example, magnetic permeability and dielectric constant) of the resin material constituting the insulator 30 and a dimension (gap between the adjacent communication lines 10) of the insulator 30.

As shown in FIG. 1, the connector 2 is connected to each of both the ends of the flat circuit body 1 in the length direction. Specifically, for example, each of the connectors 2 is electrically connected to the end in the length direction of the flat circuit body 1 by providing a hole through which the insulating protective layer 50, the shield layer 40, and the insulator 30 at the end in the length direction of the flat circuit body 1 to expose each of the plurality of communication lines 10 and the power supply line 20, and connecting the exposed lines and a terminal (not shown) on a connector 2 side with solder.

As described above, the flat circuit body 1 according to the first embodiment has a flat shape as a whole. Further, the plurality of signal lines (communication lines 10) are arranged side by side in the width direction of the flat circuit body 1, and the insulator 30 supports the plurality of signal lines 10 and the power supply line 20 in a manner of maintaining the relative positions. Accordingly, the flat circuit body 1 according to the first embodiment appropriately insulates each of the plurality of signal lines 10 from one another and appropriately insulates the plurality of signal lines 10 from the power supply line 20, while being thinner and more flexible than a circuit body in the related art which is simply made by bundling electric wires together. Therefore, the flat circuit body 1 according to the first embodiment can be wired without requiring an excessively large installation space while maintaining a function required as a circuit body.

Furthermore, in the flat circuit body 1 according to the first embodiment, the power supply line 20 has the plate shape in which the dimension in the width direction is larger than the dimension in the thickness direction of the flat circuit body 1. Accordingly, flexibility of the flat circuit body 1 in the thickness direction can be further improved.

Furthermore, in the flat circuit body 1 according to the first embodiment, the plurality of signal lines 10 and the power supply line 20 are arranged side by side in the width direction. Accordingly, the flat circuit body 1 can be further thinned as compared with a case in which the plurality of signal lines 10 and the power supply line 20 are arranged in the thickness direction.

Furthermore, in the flat circuit body 1 according to the first embodiment, the shield layer 40 is disposed in the manner of surrounding the plurality of signal lines 10 and the power supply line 20. Accordingly, it is possible to reduce the influence of the electromagnetic noise on the signal line 10 from the outside of the flat circuit body 1 and to reduce the leakage of the communication signal transmitted through the signal line 10. Furthermore, since the structure is such that the plurality of signal lines 10 and the power supply line 20 are collectively surrounded by the shield layer 40, the flat circuit body 1 can be continuously molded with high productivity by the extrusion molding or the like.

### Second Embodiment of Flat Circuit Body

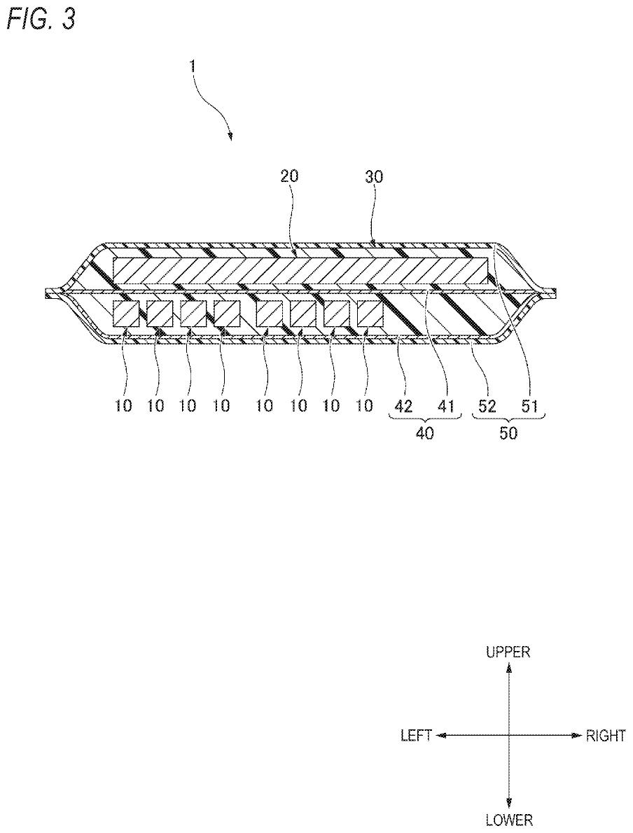

Next, the flat circuit body 1 according to a second embodiment of the present disclosure will be described with reference to FIG. 3. The flat circuit body 1 according to the second embodiment is different from the flat circuit body 1 according to the first embodiment in which the plurality of communication lines 10 and the power supply line 20 are arranged side by side in the width direction and the shield layer 40 is disposed in the manner of surrounding the plurality of communication lines 10 and the power supply line 20 in that the plurality of communication lines 10 and the power supply line 20 are arranged side by side in the thickness direction and the shield layer 40 is disposed in a manner of surrounding the plurality of communication lines 10 but not the power supply line 20. Hereinafter, the second embodiment will be described only in differences from the first embodiment.

As shown in FIG. 3, in the flat circuit body 1 according to the second embodiment, the power supply line 20 is disposed above the plurality of communication lines 10 arranged in the width direction with a gap therebetween in the thickness direction, so that the plurality of communication lines 10 and the power supply line 20 are arranged in the thickness direction. Accordingly, although a size of the flat circuit body 1 in the thickness direction is slightly increased, a size of the flat circuit body 1 in the width direction can be reduced. Furthermore, even when the plurality of communication lines 10 and the power supply line 20 are arranged side by side in the thickness direction as described above, flexibility of the flat circuit body 1 in the thickness direction is not excessively impaired.

As shown in FIG. 3, in the flat circuit body 1 according to the second embodiment, the shield layer 40 includes the thin film-shaped metal foil 41 extending in the width direction and in the length direction in a manner of traversing, in the width direction, the insulator 30 located between the plurality of communication lines 10 and the power supply line 20, which are arranged in the thickness direction, and the thin film-shaped metal foil 42 extending in the width direction and in the length direction in a manner of covering a lower face of the insulator 30. Edge portions on one side in the width direction of the metal foil 41 and the metal foil 42 and edge portions on the other side in the width direction thereof are in contact or joined in the length direction, and thus the shield layer 40 has a tubular shape extending in the length direction. As a result, the shield layer 40 is disposed in a manner of surrounding the plurality of communication lines 10 but not the power supply line 20. As described above, since the structure is such that only the plurality of communication lines 10 are surrounded by the shield layer 40, a material cost of the shield layer 40 can be reduced, and the flexibility of the flat circuit body 1 can be improved.

### Third Embodiment of Flat Circuit Body

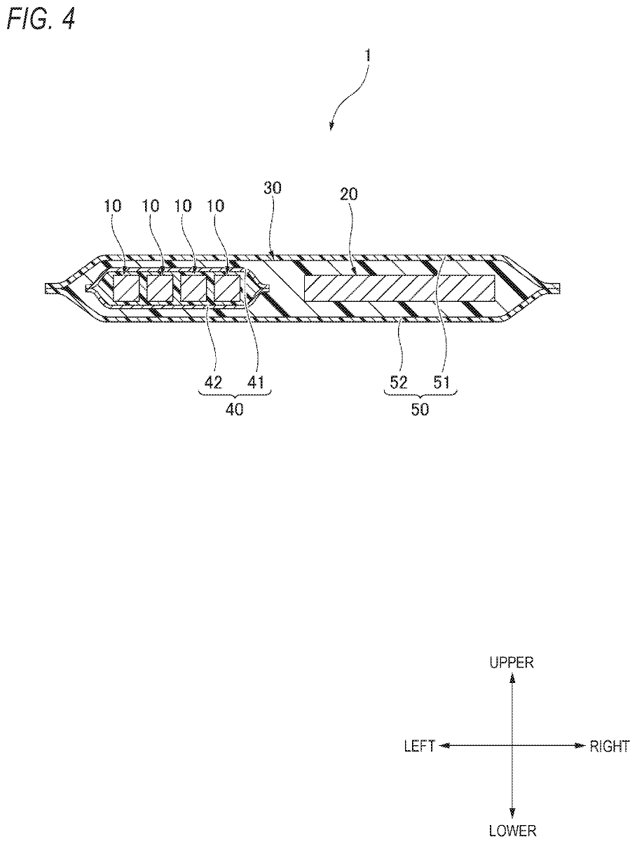

Next, the flat circuit body 1 according to a third embodiment of the present disclosure will be described with reference to FIG. 4. The flat circuit body 1 according to the third embodiment is different from the flat circuit body 1 according to the first embodiment in which the shield layer 40 is disposed in a manner of surrounding the plurality of communication lines 10 and the power supply line 20 in that the shield layer 40 is disposed in a manner of surrounding the plurality of communication lines 10 but not the power supply line 20. Hereinafter, in the third embodiment, only differences from the first embodiment will be described.

As shown in FIG. 4, in the flat circuit body 1 according to the third embodiment, the shield layer 40 includes the thin film-shaped metal foil 41 extending in the width direction and in the length direction in a manner of traversing, in the width direction, the insulator 30 located above the plurality of communication lines 10 arranged side by side in the width direction, and the thin film-shaped metal foil 42 extending in the width direction and in the length direction in a manner of traversing, in the width direction, the insulator 30 located below the plurality of communication lines 10 arranged side by side in the width direction. Edge portions on one side in the width direction of the metal foil 41 and the metal foil 42 and edge portions on the other side in the width direction thereof are joined in the length direction, and thus the shield layer 40 has a tubular shape extending in the length direction. As a result, the shield layer 40 is disposed in a manner of surrounding the plurality of communication lines 10 but not the power supply line 20. As described above, since the structure is such that only the plurality of communication lines 10 are surrounded by the shield layer 40, a material cost of the shield layer 40 can be reduced, and flexibility of the flat circuit body 1 can be improved.

### Embodiment of Circuit Wiring Structure

The flat circuit body 1 according to each of the first to third embodiments is mounted and used in a vehicle 3 as shown in FIG. 5, for example, in a state in which the connector 2 is connected to each of both the ends in the length direction (see FIG. 1). In the example shown in FIG. 5, a plurality of electric junction boxes 4 (for example, ECU or the like in which a control device is built) are respectively disposed in a plurality of regions of the vehicle 3, and each of a plurality of flat circuit bodies 1 is wired to connect a corresponding pair of electric junction boxes 4 among the plurality of electric junction boxes 4. The connector 2 connected to each of both the ends of the plurality of flat circuit bodies 1 is electrically connected to the corresponding electric junction box 4 by being connected to a connector portion (not shown) provided in the corresponding electric junction box 4. A plurality of electric wires 5 respectively connected to various loads (not shown) mounted on the vehicle 3 extend from each of the plurality of electric junction boxes 4.

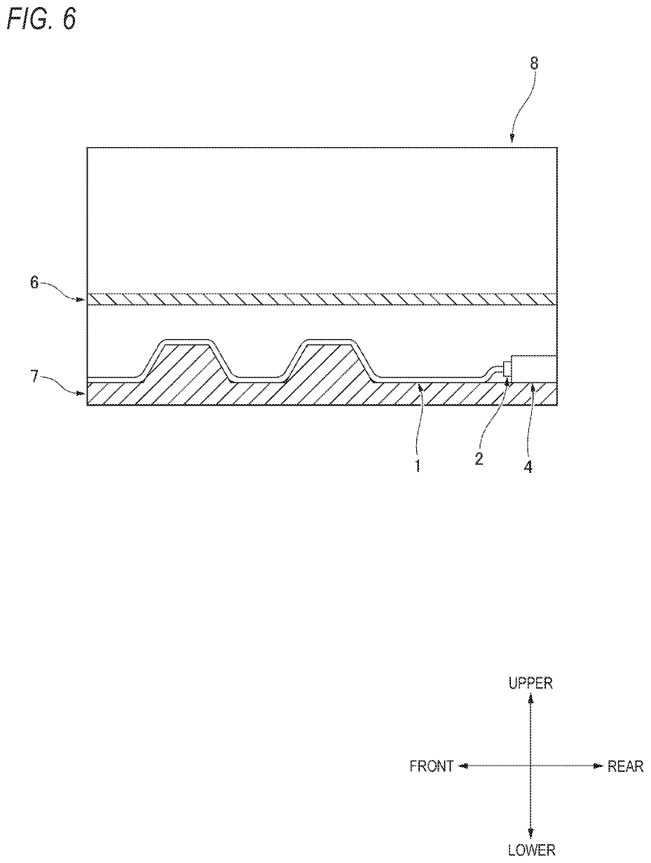

Specifically, as shown in FIG. 6, each of the plurality of flat circuit bodies 1 is wired while being curved along a surface shape under the floor of the vehicle 3. In an example shown in FIG. 6, the flat circuit body 1 is wired while being flexibly curved in accordance with unevenness of an upper face of a floor panel 7 located below a floor plate 6 of the vehicle 3. Here, a circuit wiring structure 8 according to the embodiment of the present disclosure is formed by the pair of electric junction boxes 4, the flat circuit body 1, and the floor panel 7 of the vehicle 3 on which the flat circuit body 1 is wired.

According to the circuit wiring structure 8 according to the embodiment of the present disclosure, the flat circuit body 1 is wired between the pair of electric junction boxes 4 so as to electrically connect the pair of electric junction boxes 4 while being curved along the surface shape of a wiring target (floor panel 7). Accordingly, it is possible to electrically connect the pair of electric junction boxes 4 without requiring an excessively large space on the wiring target 7.

### Other Embodiments

The present disclosure is not limited to the embodiments described above, and various modifications can be adopted within the scope of the present disclosure. For example, the present disclosure is not limited to the embodiments described above, and modifications, improvements, and the like can be appropriately made. In addition, materials, shapes, sizes, numbers, arrangement positions, or the like of components in the embodiment described above are freely selected and are not limited as long as the present disclosure can be implemented.

For example, in the above embodiments, the plurality of communication lines 10 and the power supply line 20 are embedded in the insulator 30. On the other hand, the plurality of communication lines 10 and the power supply line 20 may be supported by the insulator 30 in a form other than embedding. For example, the plurality of communication lines 10 and the power supply line 20 may be supported by a sheet-shaped insulator by being held on a surface of the insulator in a form such as welding.

Further, in the above embodiments, the shield layer 40 has the tubular shape. On the other hand, for example, a pair of thin plate-shaped shield layers 40 may be disposed in a manner of sandwiching the plurality of communication lines 10 in the thickness direction. Furthermore, for example, in a case in which it is sufficient to provide a shielding function only on one side in the thickness direction, the shield layer 40 may be disposed on only that one side of the plurality of communication lines 10.

Further, in the above embodiments, the connector 2 is attached to the flat circuit body 1. On the other hand, for example, the connector 2 may be mounted on a predetermined circuit substrate, and the end of the flat circuit body 1 may be connected to the circuit substrate. That is, a structure (so-called card edge) in which the flat circuit body 1 and the connector 2 are connected via the circuit substrate may be adopted.

Here, features of the embodiments of the flat circuit body 1 and the circuit wiring structure 8 according to the present disclosure described above are briefly summarized and listed in the following [1] to [7].

A flat circuit body (1) having a flat shape, the flat circuit body (1) including:
a plurality of signal lines (10) configured to transmit a communication signal;
a power supply line (20) configured to transmit power;
an insulator (30) that supports the plurality of signal lines (10) and the power supply line (20); and
an electric conductive shield layer (40), in which
the plurality of signal lines (10) are arranged side by side with a gap therebetween in a width direction of the flat circuit body (1),
the power supply line (20) has a cross-sectional area larger than a cross-sectional area of one of the signal lines (10) and is disposed with a gap from the plurality of signal lines (10), and
the insulator (30) supports the plurality of signal lines (10) and the power supply line (20) in a manner of maintaining relative positions of the plurality of signal lines (10) and the power supply line (20).

The flat circuit body having the above configuration of [1] has the flat shape as a whole. Further, the plurality of signal lines are arranged side by side with a gap therebetween in the width direction of the flat circuit body, and the power supply line is disposed with a gap from the plurality of signal lines. Further, the insulator supports the plurality of signal lines and the power supply line in a manner of maintaining the relative positions. Accordingly, the flat circuit body having this configuration can appropriately insulate each of the plurality of signal lines from one another and appropriately insulate the plurality of signal lines from the power supply line. Further, since the circuit body according to the present configuration has the flat shape, a thickness can be reduced and flexibility can be improved as compared with a case in which electric wires are simply bundled together as in the circuit body in the related art. Therefore, the flat circuit body having this configuration can be wired without requiring an excessively large installation space while maintaining a function required as a circuit body.

The flat circuit body (1) according to [1], in which
the power supply line (20) has a plate shape in which a dimension of the power supply line (20) in the width direction is larger than a dimension of the power supply line (20) in a thickness direction of the flat circuit body (1).

In the flat circuit body having the above configuration of [2], the power supply line has the plate shape in which the dimension in the width direction is larger than the dimension in the thickness direction of the flat circuit body. Accordingly, the flexibility of the flat circuit body in the thickness direction can be further improved.

The flat circuit body (1) according to [1], in which
the plurality of signal lines (10) and the power supply line (20) are arranged side by side in the width direction.

In the flat circuit body having the above configuration of [3], the plurality of signal lines and the power supply line are arranged side by side in the width direction. Accordingly, the flat circuit body can be further thinned.

The flat circuit body (1) according to [1], in which
the plurality of signal lines (10) and the power supply line (20) are arranged side by side in a thickness direction of the flat circuit body (1).

In the flat circuit body having the above configuration of [4], the plurality of signal lines and the power supply line are arranged side by side in the thickness direction. Accordingly, although a size of the flat circuit body in the thickness direction is slightly increased, a size of the flat circuit body in the width direction can be reduced.

The flat circuit body (1) according to [1], in which
the shield layer (40) is disposed in a manner of surrounding the plurality of signal lines (10) and the power supply line (20).

In the flat circuit body having the above configuration of [5], the shield layer is disposed in a manner of surrounding the plurality of signal lines and the power supply line. Accordingly, it is possible to reduce an influence of an electromagnetic noise on the signal lines from an outside of the flat circuit body and to reduce leakage of the communication signal transmitted through the signal lines. Furthermore, since the structure is such that the plurality of signal lines and the power supply line are collectively surrounded by the shield layer, the flat circuit body can be continuously molded with high productivity by extrusion molding or the like.

The flat circuit body (1) according to [1], in which
the shield layer (40) is disposed in a manner of surrounding the plurality of signal lines (10) but not the power supply line (20).

The flat circuit body having the above configuration of [6] is disposed in the manner of surrounding the plurality of signal lines but not the power supply line. Accordingly, it is possible to reduce the influence of the electromagnetic noise on the signal lines from the outside of the flat circuit body and to reduce the leakage of the communication signal transmitted through the signal lines. Since the structure is such that only the plurality of signal lines are surrounded by the shield layer, a material cost of the shield layer can be reduced, and the flexibility of the flat circuit body can be improved.

A circuit wiring structure (8) including:
a pair of electric junction boxes (4);
the flat circuit body (1) according to any one of [1] to [6]; and
a wiring target (7) in which the flat circuit body (1) is wired, in which
the flat circuit body (1) is wired between the pair of electric junction boxes (4) to electrically connect the pair of electric junction boxes (4) while being curved along a surface shape of the wiring target (7).

According to the circuit wiring structure having the above configuration of [7], by using the flat circuit body described above, it is possible to electrically connect the pair of electric junction boxes (for example, ECU or the like in which a control device is built) by the flat circuit body while curving the flat circuit body along the surface shape of the wiring target (for example, a floor material) between the pair of electric junction boxes. Accordingly, it is possible to appropriately electrically connect the pair of electric junction boxes without requiring an excessively large space on the wiring target.

What is claimed is:

1. A flat circuit body having a flat shape, the flat circuit body comprising:
a plurality of signal lines that transmit a communication signal;
a power supply line that transmits power;
an insulator that supports the plurality of signal lines and the power supply line; and
an electric conductive shield layer, wherein
the plurality of signal lines are spaced apart from each other with a gap therebetween in a width direction of the flat circuit body,
the power supply line has a cross-sectional area larger than a cross-sectional area of one of the plurality of signal lines and is disposed with a gap from the plurality of signal lines, and
the insulator supports the plurality of signal lines and the power supply line in a manner of maintaining relative positions of the plurality of signal lines and the power supply line.

2. The flat circuit body according to claim 1, wherein
the power supply line has a plate shape in which a dimension of the power supply line in the width direction is larger than a dimension of the power supply line in a thickness direction of the flat circuit body.

3. The flat circuit body according to claim 1, wherein
the plurality of signal lines and the power supply line are arranged side by side in the width direction.

4. The flat circuit body according to claim 1, wherein
the plurality of signal lines and the power supply line are arranged side by side in a thickness direction of the flat circuit body.

5. The flat circuit body according to claim 1, wherein
the shield layer is disposed in a manner of surrounding the plurality of signal lines and the power supply line.

6. The flat circuit body according to claim 1, wherein
the shield layer is disposed in a manner of surrounding the plurality of signal lines but not the power supply line.

7. A circuit wiring structure comprising:
a pair of electric junction boxes;
the flat circuit body according to claim 1; and
a wiring target in which the flat circuit body is wired, wherein
the flat circuit body is wired between the pair of electric junction boxes to electrically connect the pair of electric junction boxes while being curved along a surface shape of the wiring target.
